(19) United States
(12) Patent Application Publication
(10) Pub. No.: US 2017/0333779 A1
(43) Pub. Date: Nov. 23, 2017

(54) System and Method for Invitation to Games or Sports

(71) Applicant: Terence Faycal El Labban, Paris (FR)

(72) Inventor: Terence Faycal El Labban, Paris (FR)

(21) Appl. No.: 15/598,060

(22) Filed: May 17, 2017

Related U.S. Application Data
(60) Provisional application No. 62/337,915, filed on May 18, 2016.

(51) Int. Cl. A63B 71/06; G06Q 30/02; H04L 29/06; G07C 13/00; G06Q 50/00

(52) U.S. Cl. CPC A63B 71/0616; H04L 63/08; G07C 13/00; A63B 71/0622; G06Q 30/0274; A63B 71/0697; G06Q 50/01

(57) ABSTRACT

In one example, we describe a method and system for invitation to games or sports. For example, when the user uses our system (PlayUs), she or he gets connected to others very easily (e.g., in the city's “Open League”). This way, the player/user is immediately presented with a feed of all recent activities and has immediate access to all active players in the area. The user can also access his/her friends through the social networks, to increase participation very rapidly. One can also make groups and find new friends using our app (mobile application), e.g., with mobile phones or devices. One can also be discovered by others, depending on the level of privacy desired or previously set. Many different variations or combinations are also shown here.

### RELATED APPLICATIONS

The current application is based on a pending provisional U.S. patent application 62/337,915, with the same title, inventor, and assignee, filed May 18, 2016. We incorporate herein by reference all teachings of the parent/provisional application, and we claim priority to the filing of that parent/provisional application.

### BACKGROUND OF THE INVENTION

Imagine that you go to another city or country for a short trip, and you want to play soccer, while you are there, but you do not know anybody there. So, there is a need for such a system to help bring people together for such events, and find proper venue for such an activity.

The prior art and the existing apps (called SportsBuddy and PlayWith) are not good solutions, as they miss a lot of important features, as we explain and present here. That is, the invention and embodiments described here have not been addressed or presented in any prior art.

### SUMMARY OF THE INVENTION

In one embodiment, we describe a System and Method for Invitation to Games or Sports. Different embodiments of the invention are shown in different figures attached to this application. Other interfaces and examples are shown in the Appendices. Any variations or combinations of these embodiments are also meant to be included in the current invention for protection.

In one embodiment, when the user uses our system (PlayUs), she or he gets connected to others very easily (e.g., in the city's “Open League”). This way, the player/user is immediately presented with a feed of all recent activities and has immediate access to all active players in the area. The user can also access his/her friends through the social networks, such as FACEBOOK or TWITTER, to increase participation very rapidly.

One can also make groups and find new friends using our app (mobile application) with mobile phones or devices. One can also be discovered by others, depending on the level of privacy desired/previously set.

### BRIEF DESCRIPTION OF THE DRAWINGS

FIG. 1 is for one embodiment, as an example, for invitation of others to the game.

FIG. 2 is for one embodiment, as an example, for searching vicinity for match.

FIG. 3 is for one embodiment, as an example, for matching the player.

FIG. 4 is for one embodiment, as an example, for demand for a good player.

FIG. 5 is for one embodiment, as an example, for ranking the player.

FIG. 6 is for one embodiment, as an example, for selecting teammates.

FIG. 7 is for one embodiment, as an example, for video display site.

FIG. 8 is for one embodiment, as an example, for tagging the video.

FIG. 9 is for one embodiment, as an example, for purchasing or renting equipment or supplies.

FIG. 10 is for one embodiment, as an example, for getting a stadium or playground.

FIG. 11 is for one embodiment, as an example, for making a league.

FIG. 12 is for one embodiment, as an example, for conditional acceptance.

FIG. 13 is for one embodiment, as an example, for various sports.

FIG. 14 is for one embodiment, as an example, for matching people.

FIG. 15 is for one embodiment, as an example, for selecting a player, coach, or referee.

FIG. 16 is for one embodiment, as an example, for auctions.

FIG. 17 is for one embodiment, as an example, for a league or tournament.

FIG. 18 is for one embodiment, as an example, for renting facilities.

FIG. 19 is for one embodiment, as an example, for filtering topics.

FIG. 20 is for one embodiment, as an example, for video repository.

FIG. 21 is for one embodiment, as an example, for ads.

FIG. 22 is for one embodiment, as an example, for main server.

FIG. 23 is for one embodiment, as an example, for user's data.

FIG. 24 is for one embodiment, as an example, for more user's data.

FIG. 25 is for one embodiment, as an example, for user's options.

FIG. 26 is for one embodiment, as an example, for other user's data.

FIG. 27 is for one embodiment, as an example, for more user interface options.

FIG. 28 is for one embodiment, as an example, for notices.

FIG. 29 is for one embodiment, as an example, for our system, with the subcomponents of the system.

FIG. 30 is for one embodiment, as an example, for our system, with the subcomponents of the system.

### DETAILED DESCRIPTION OF THE PREFERRED EMBODIMENTS

In one embodiment, we provide tools, system, and platforms, with associated methods to make a team building or league building in a city or region, from scratch, for games or sports or social events, very easily and conveniently, which would be otherwise impossible to coordinate or gather people together.

Appendix 1 shows the mobile interface for one embodiment, e.g., activity feed, player's profile, league details, game details, team profiles, sports details, messaging, search, captain messaging, and game management, e.g., for selecting sports as volleyball, or for editing games, e.g., rescheduling, changing, canceling, or suggesting for alternative time, or voting for such, or veto such votes, or who has the authorization to do such, for changes or editing, as manager, captain, organizer, sponsor, team owner, league owner, venue owner, user, player, admin, public, or the like.

The permission or authorization can be delegated to others for editing. It can be password or biometric based for authentication. Web interface may have the following features for one embodiment: dashboard, reporting, sports, leagues, teams, users, games, and play fields, as shown in Appendix 1, page 16. It can also have MVP voting, per game or for season or city-wide or nation-wide, tournament scheduling, game photos, and auto-scheduling, with screenshots shown or examples for interfaces.

Appendix 2 shows game scheduling and notifications, as methods or flowcharts. Appendix 3 shows voting on game MVP, with flowcharts and procedures. Appendix 4 shows a player joining a league with payment, with flowcharts. Appendix 5 shows layer requesting a team, team captain approving the team members, team captain promoting team members to co-captain, league commissioner promoting players to co-commissioner, and team captain adding players to the team, with flowcharts and procedures.

Appendix 6 shows player profile creation and modification, and viewing other profiles, with flowcharts and procedures. Appendix 7 shows scoring types, with flowcharts and procedures. Appendix 8 shows social sharing, with flowcharts and procedures. Appendix 9 shows team members messaging in app, with flowcharts and procedures.

Appendix 10 shows account creation, with interfaces and screenshots, groups and group management, map and games, and additional screens, e.g., for chronological and alphabetical listings or ordering or searching or display, with color coding and pictures, if selected and loaded, as an option, with affiliations and road/routing/directions/map, with details of the games and user-interface, which is very easy to navigate.

Appendix 11 shows interfaces for user-interface with screenshots for various functions and features, e.g., title screen, tutorial, Facebook login, account creation, specific sports info, welcome message, group page, group page with swiped banner, game creation, map welcome message, map, and list view, with all details needed for players or the game, for coordination and notices for such.

Appendix 12 shows interfaces for user-interface with screenshots for various functions and features, e.g., for wireframes, mockups for account creation, groups and group management, map & games, and other screens for other listings or ordering or reminders or choices, as shown in Appendix 12, page 5. Appendix 13 shows the app, Venu, e.g., for league creation and management, with user-interface with screenshots.

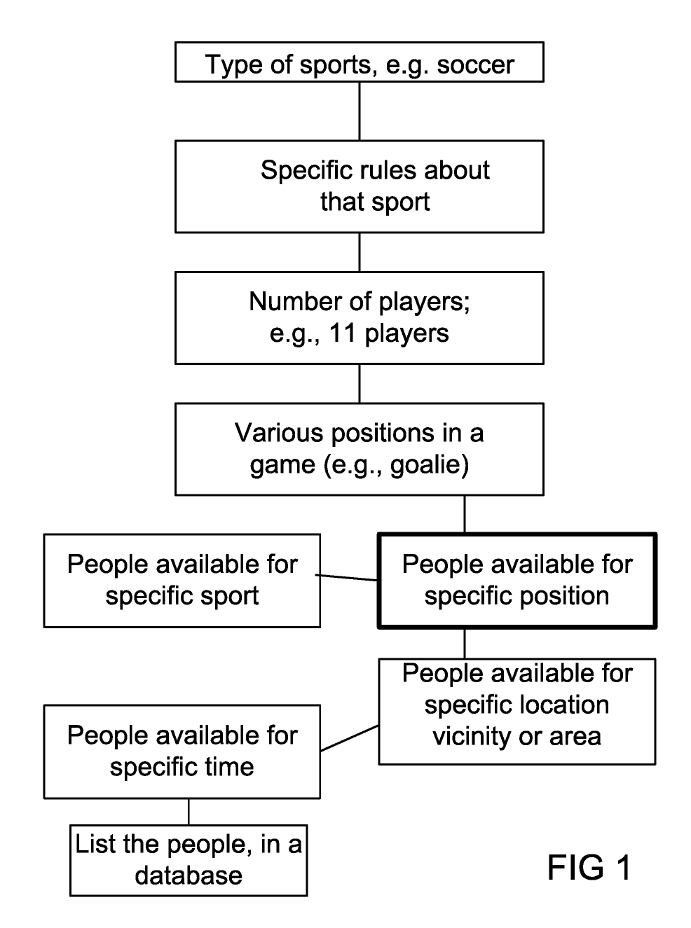

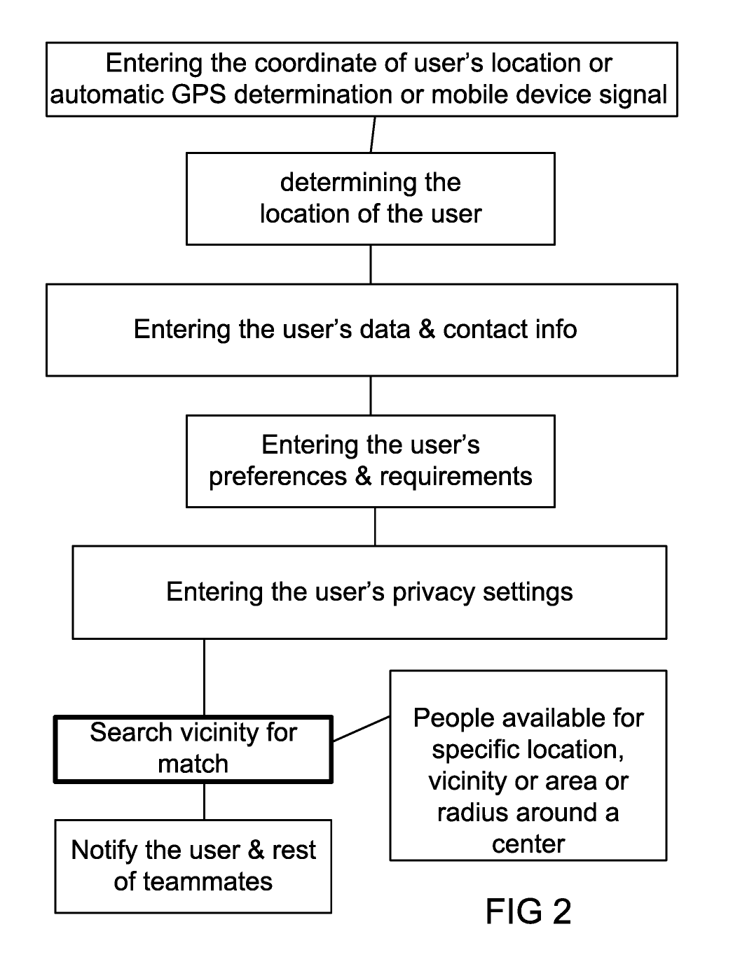

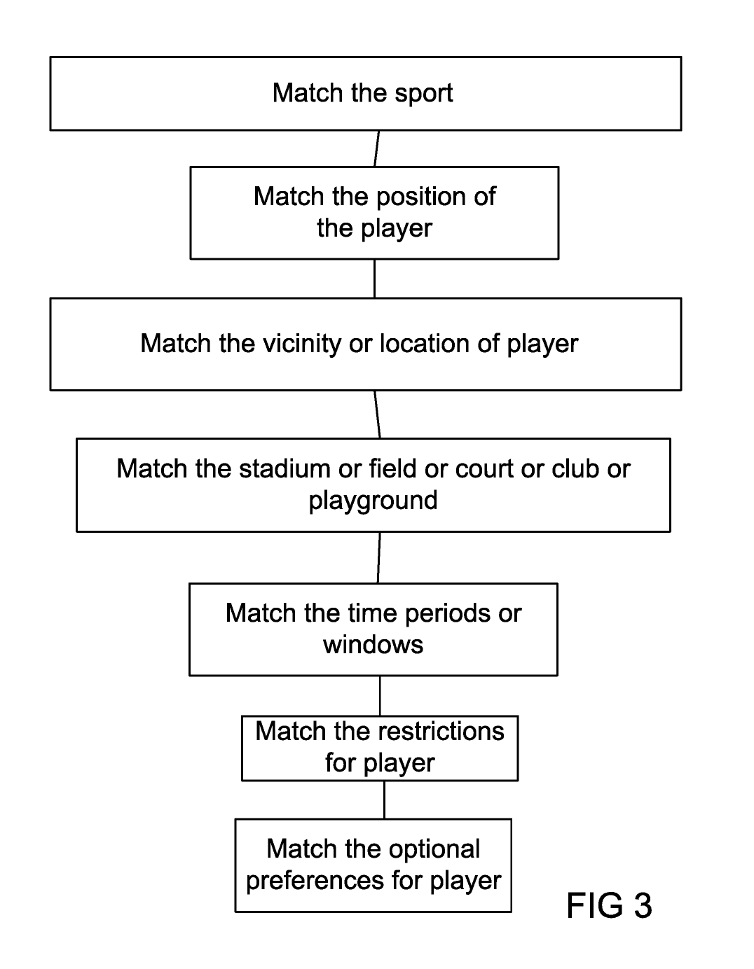

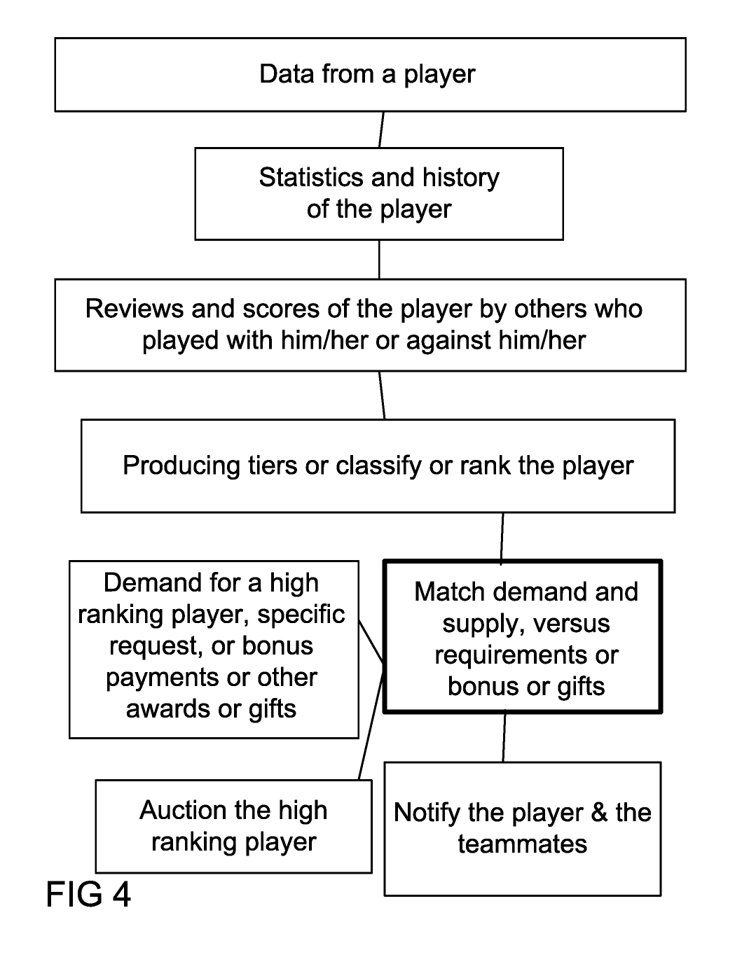

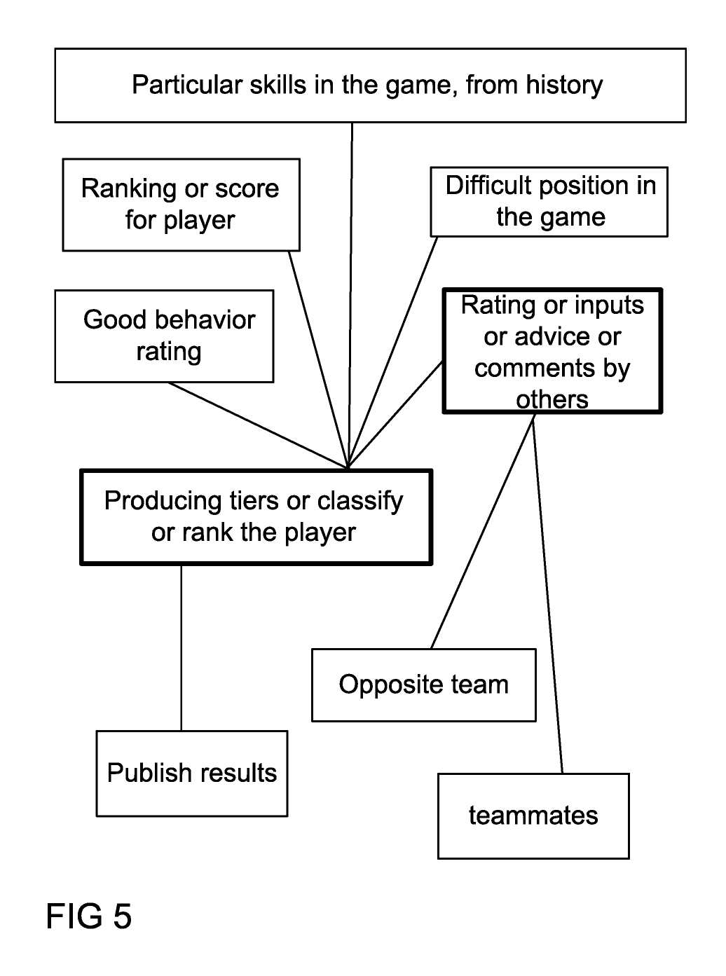

FIG. 1 is for one embodiment, as an example, for invitation of others to the game. FIG. 2 is for one embodiment, as an example, for searching vicinity for match. FIG. 3 is for one embodiment, as an example, for matching the player. FIG. 4 is for one embodiment, as an example, for demand for a good player. FIG. 5 is for one embodiment, as an example, for ranking the player.

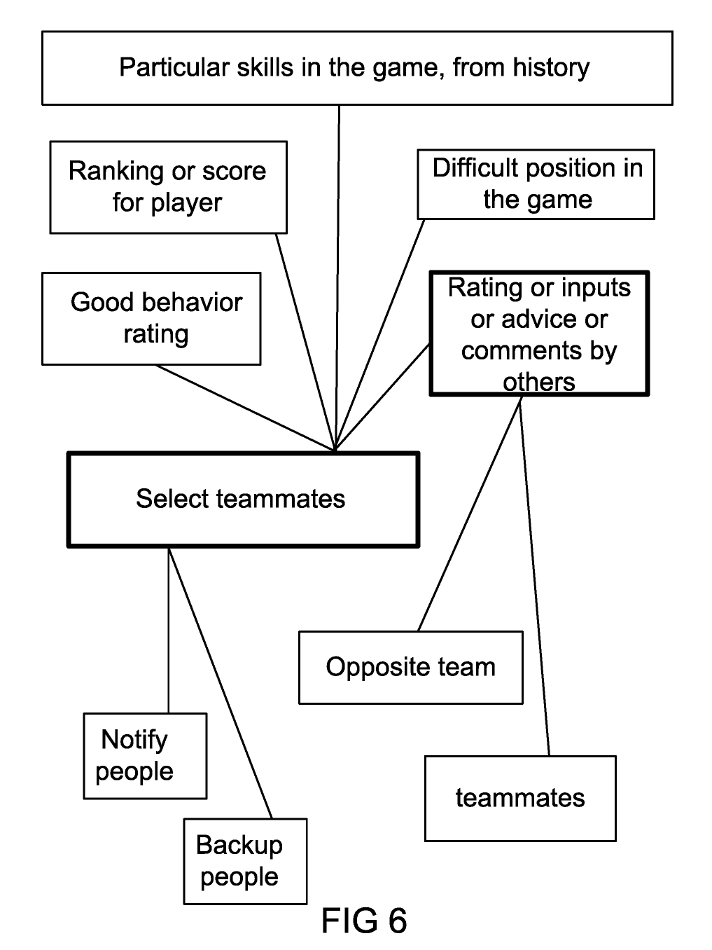

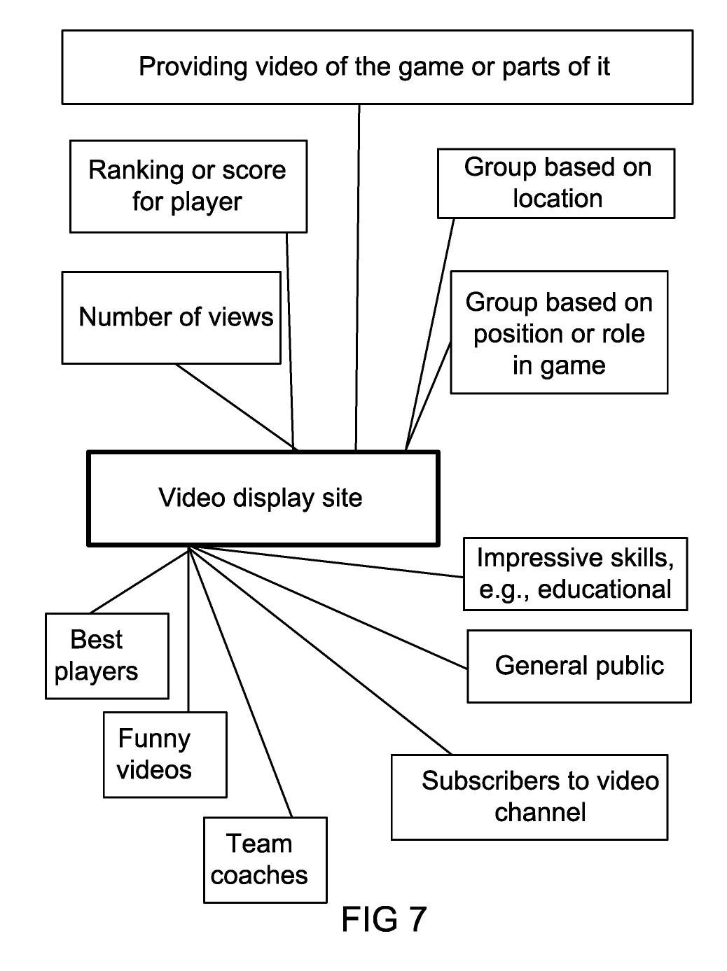

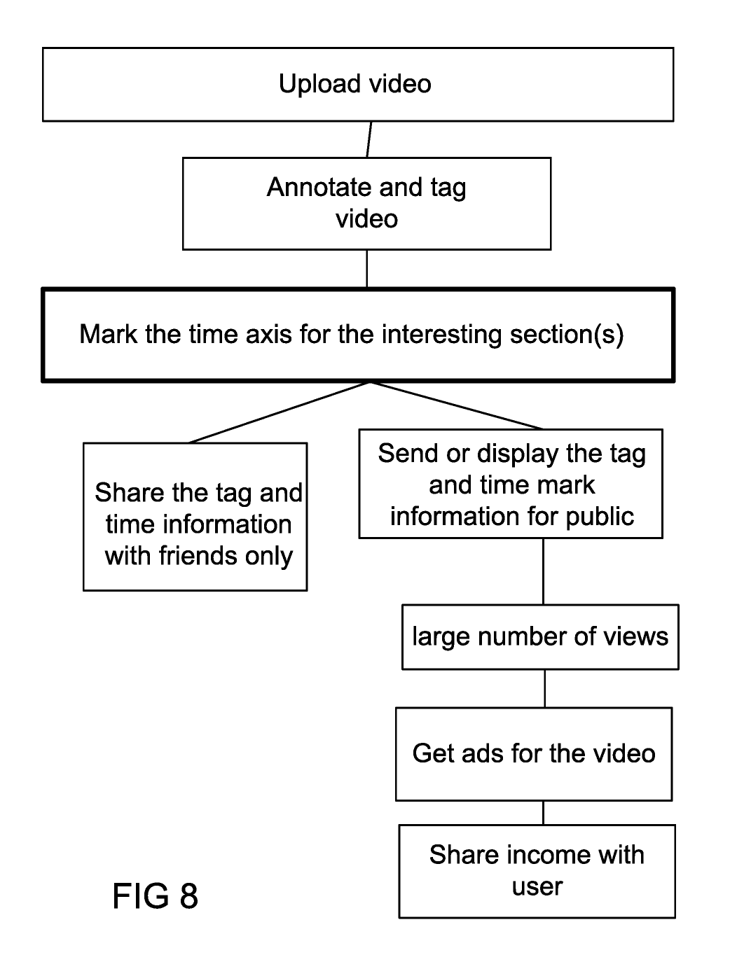

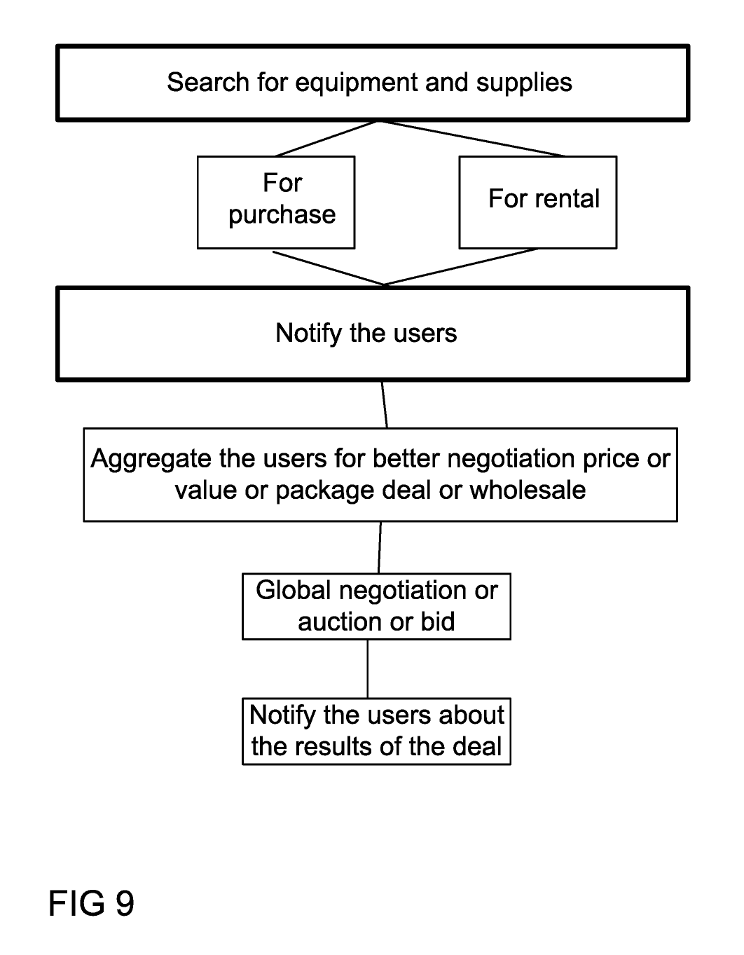

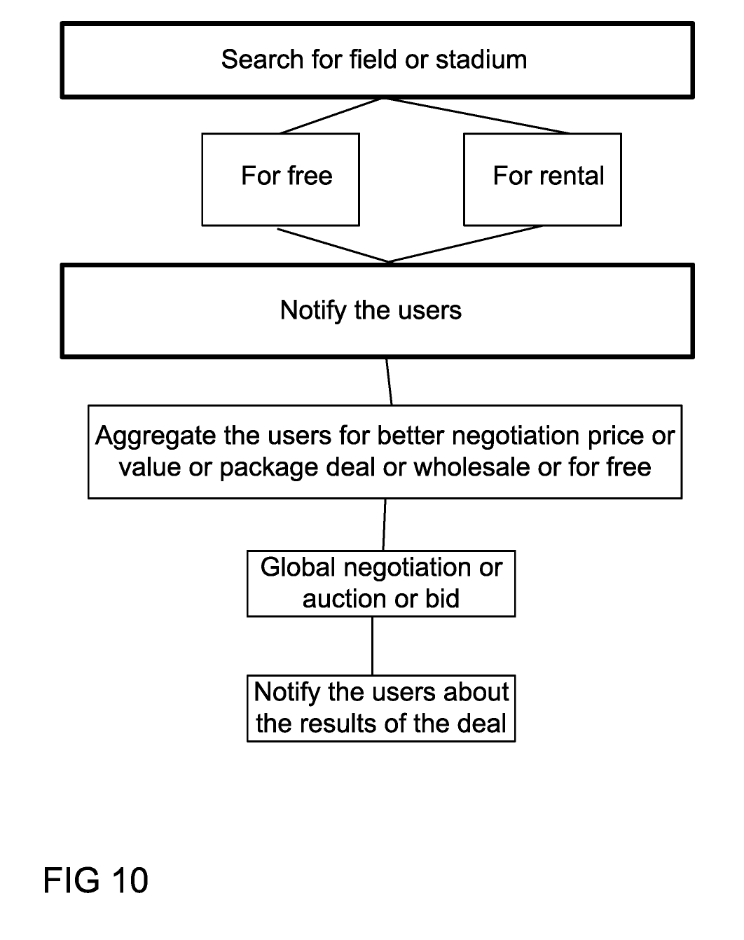

FIG. 6 is for one embodiment, as an example, for selecting teammates. FIG. 7 is for one embodiment, as an example, for video display site. FIG. 8 is for one embodiment, as an example, for tagging the video. FIG. 9 is for one embodiment, as an example, for purchasing or renting equipment or supplies. FIG. 10 is for one embodiment, as an example, for getting a stadium or playground.

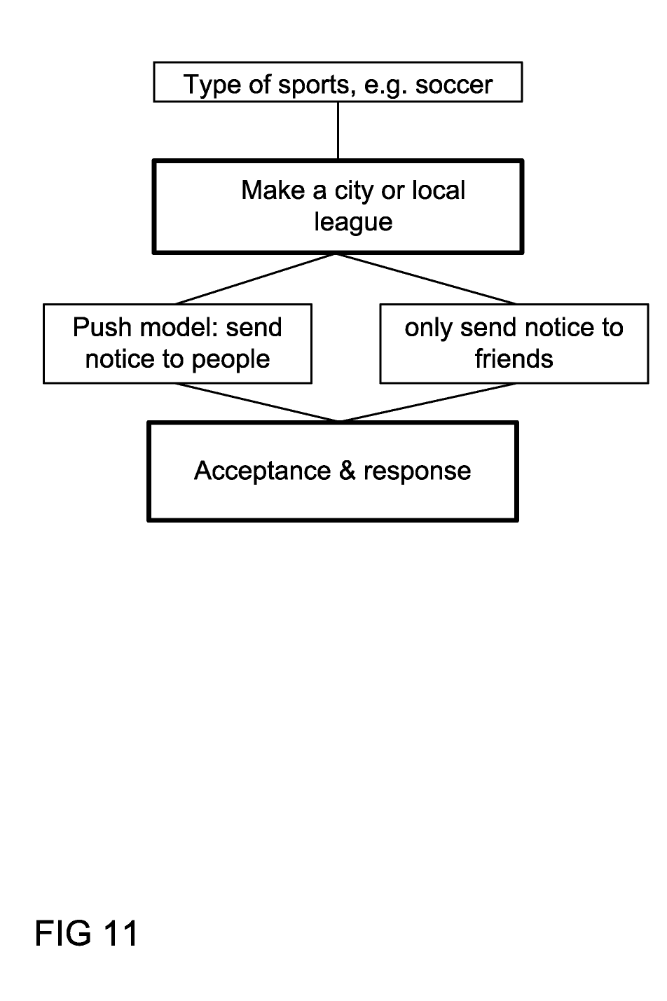

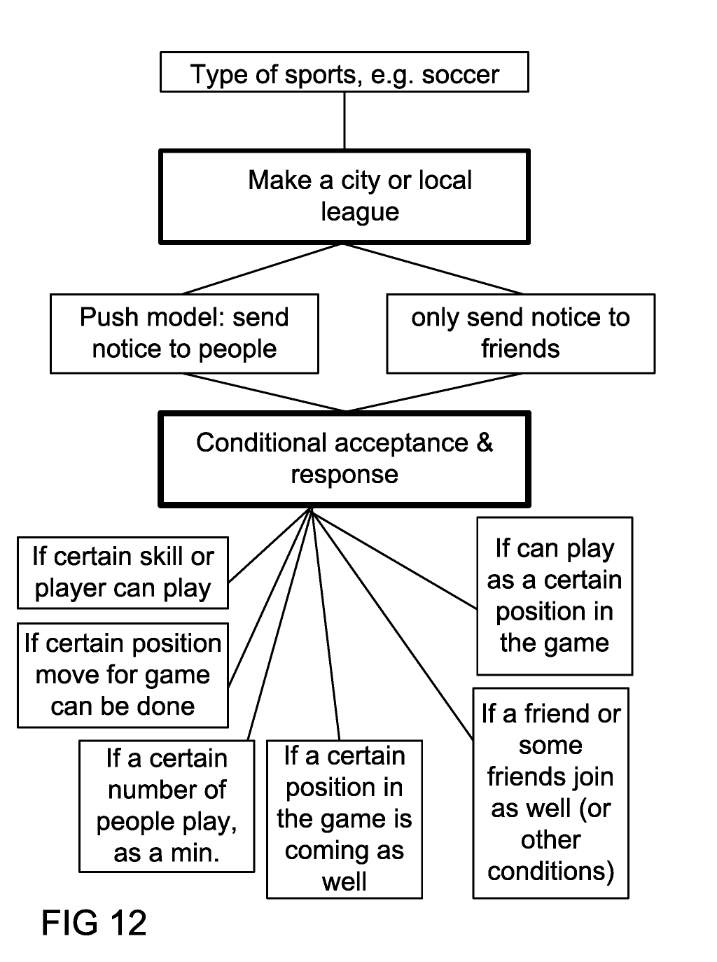

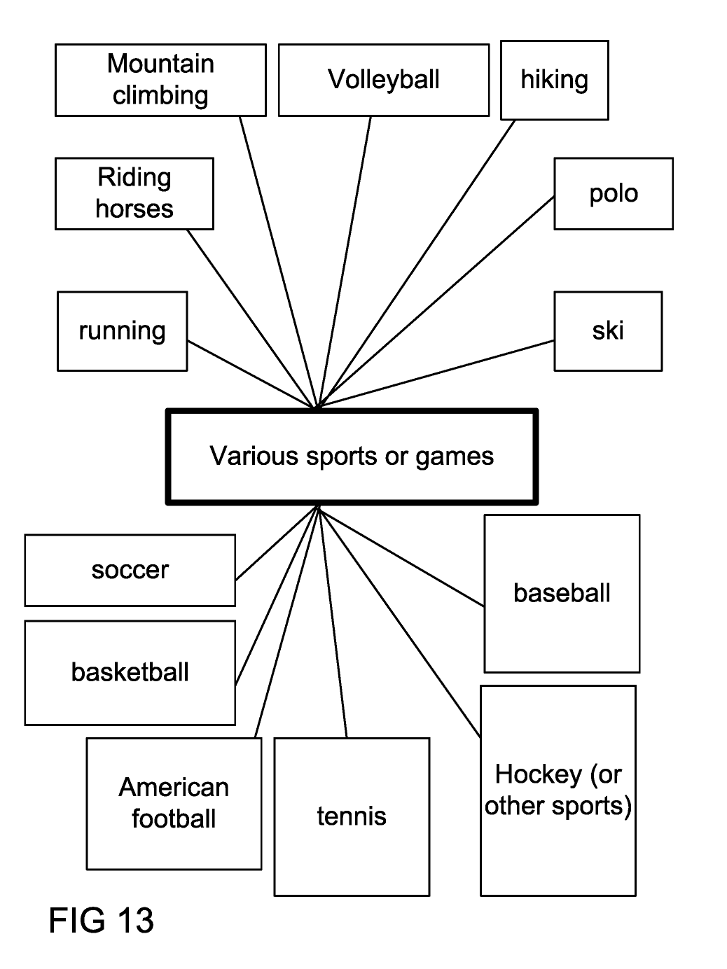

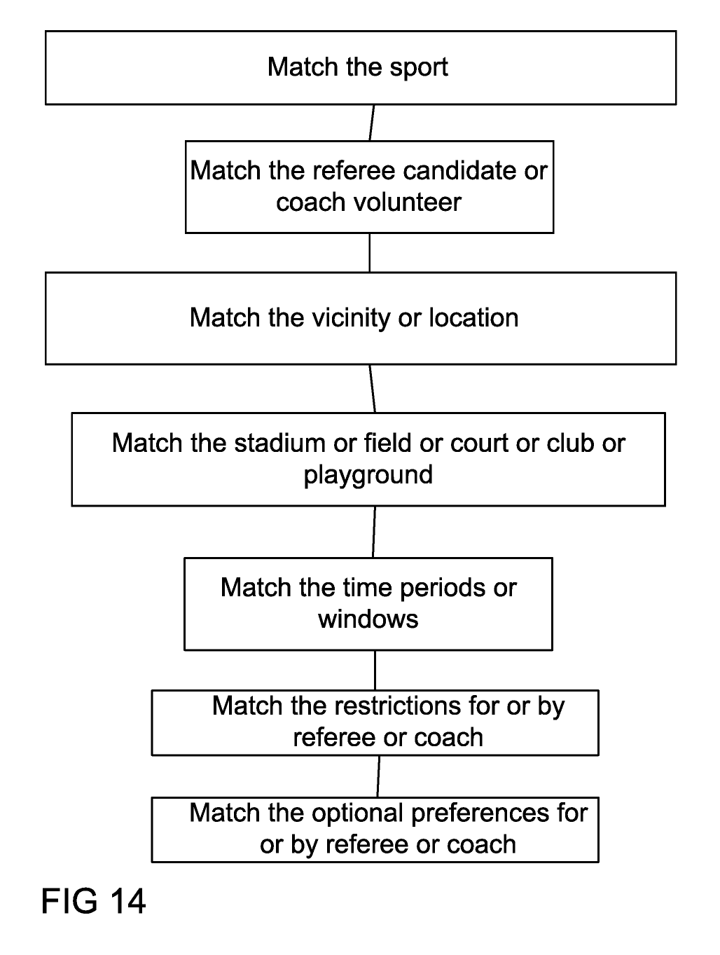

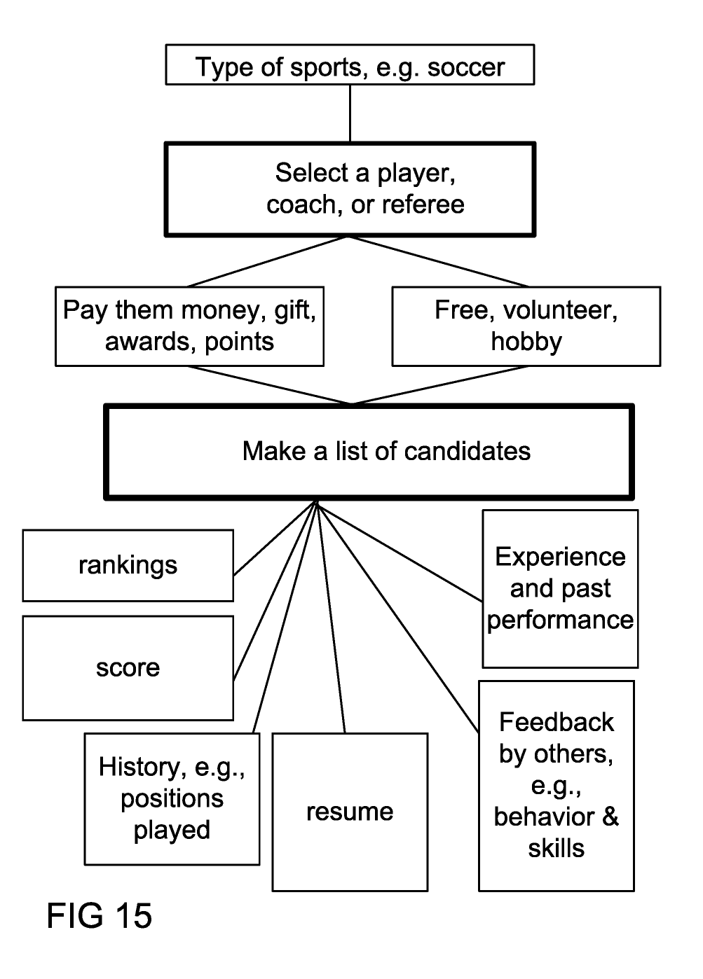

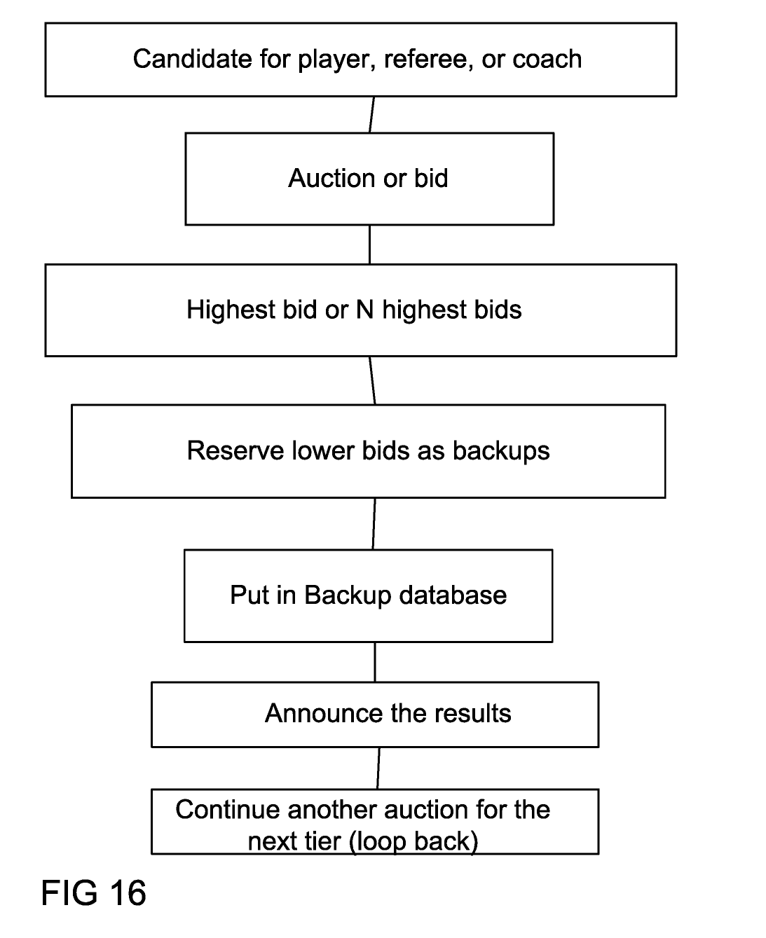

FIG. 11 is for one embodiment, as an example, for making a league. FIG. 12 is for one embodiment, as an example, for conditional acceptance. FIG. 13 is for one embodiment, as an example, for various sports. FIG. 14 is for one embodiment, as an example, for matching people. FIG. 15 is for one embodiment, as an example, for selecting a player, coach, or referee. FIG. 16 is for one embodiment, as an example, for auctions.

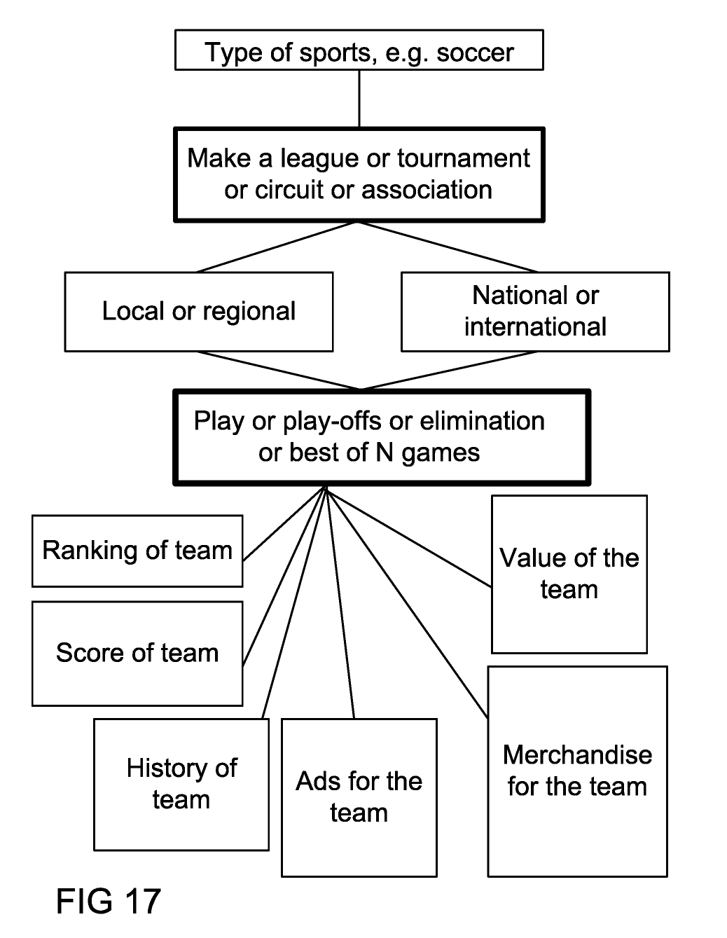

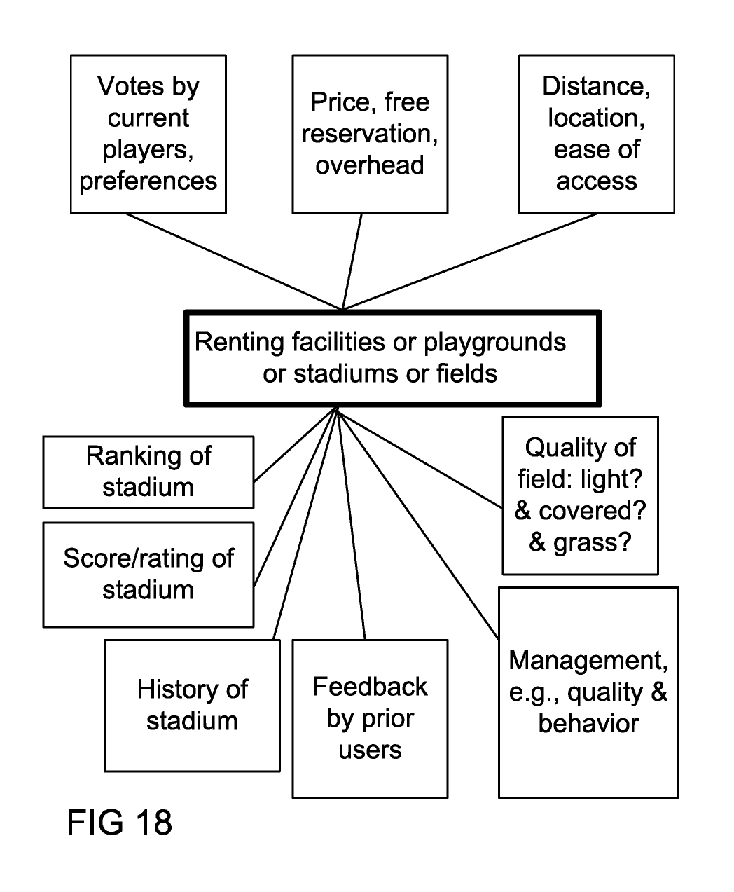

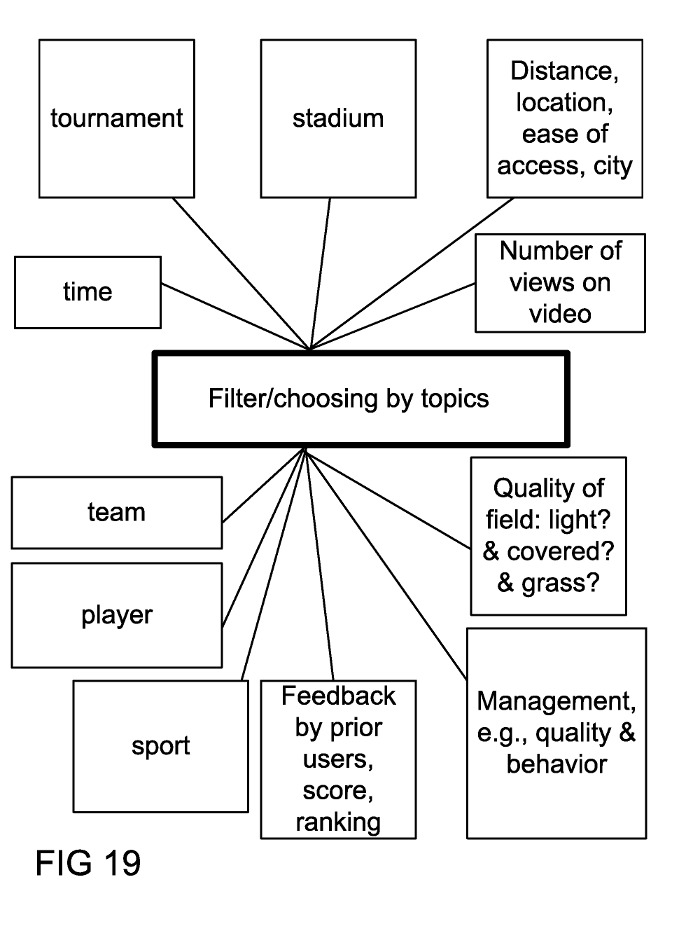

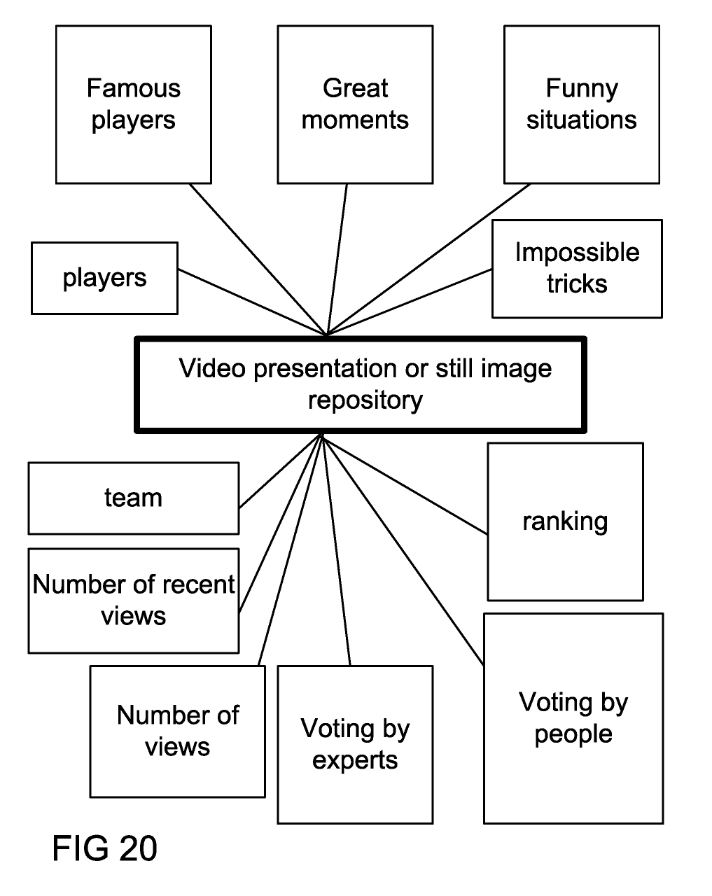

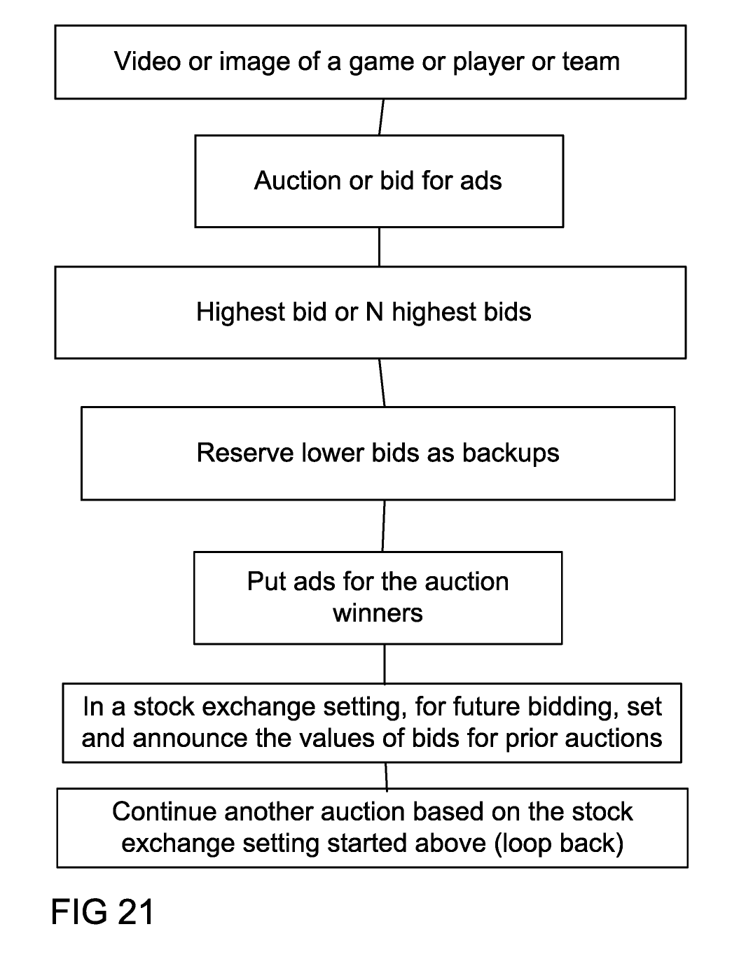

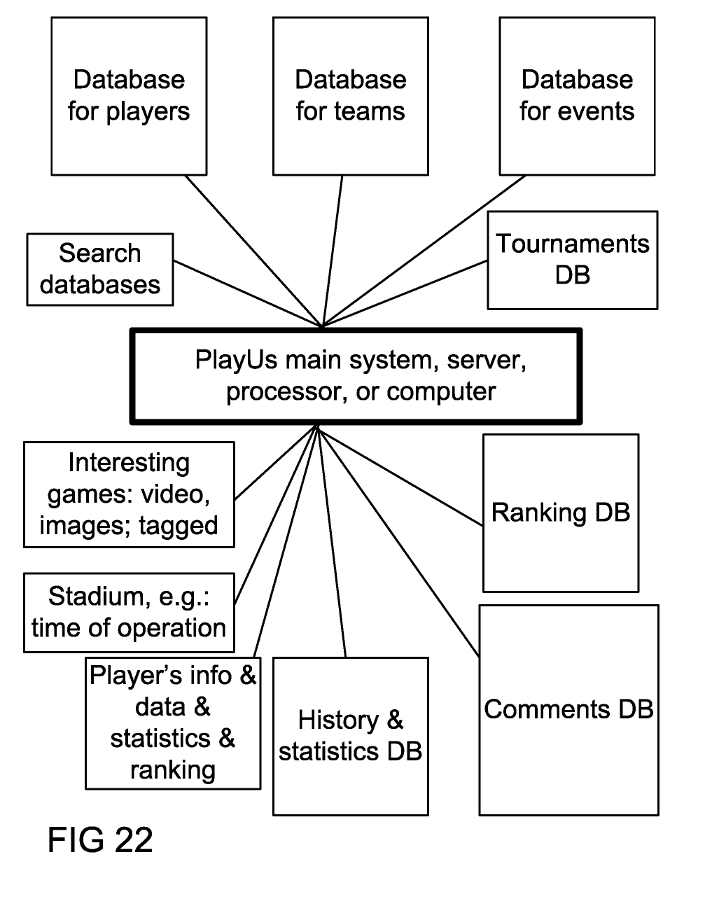

FIG. 17 is for one embodiment, as an example, for a league or tournament. FIG. 18 is for one embodiment, as an example, for renting facilities. FIG. 19 is for one embodiment, as an example, for filtering topics. FIG. 20 is for one embodiment, as an example, for video repository. FIG. 21 is for one embodiment, as an example, for ads. FIG. 22 is for one embodiment, as an example, for main server.

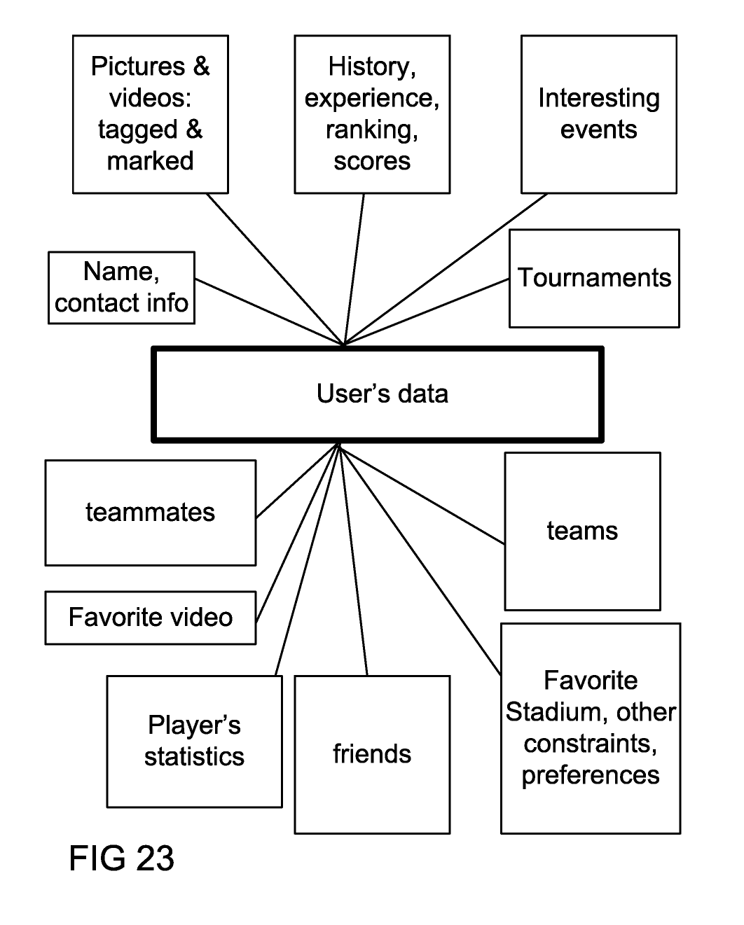

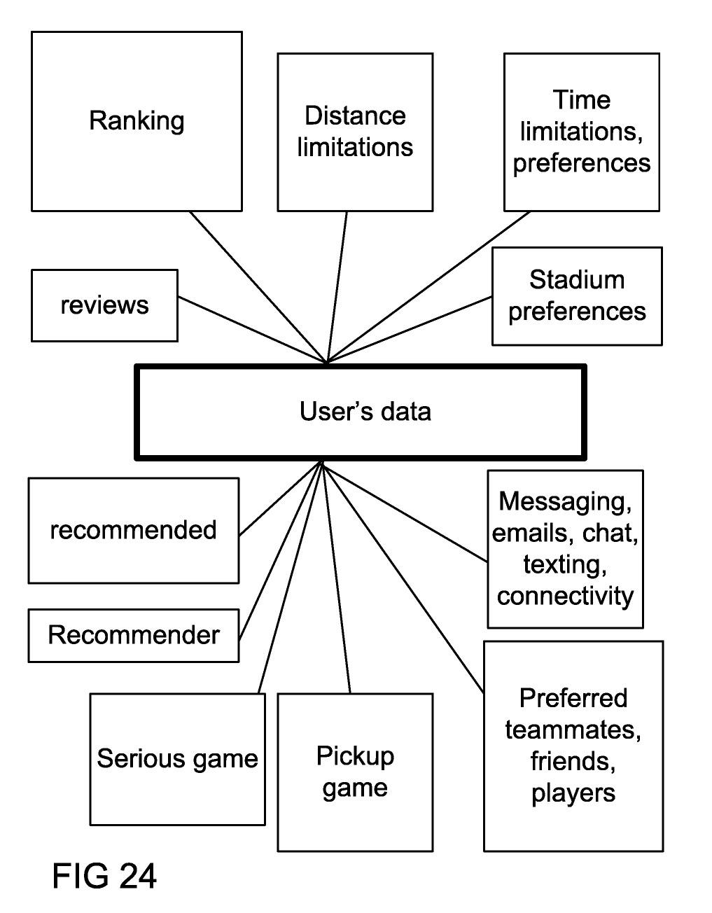

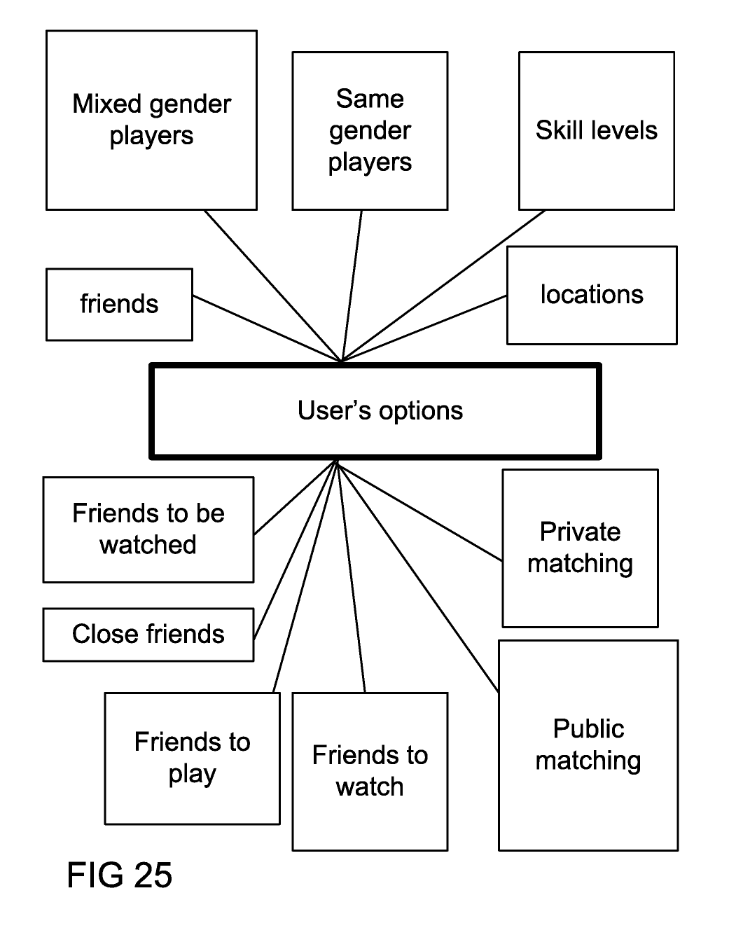

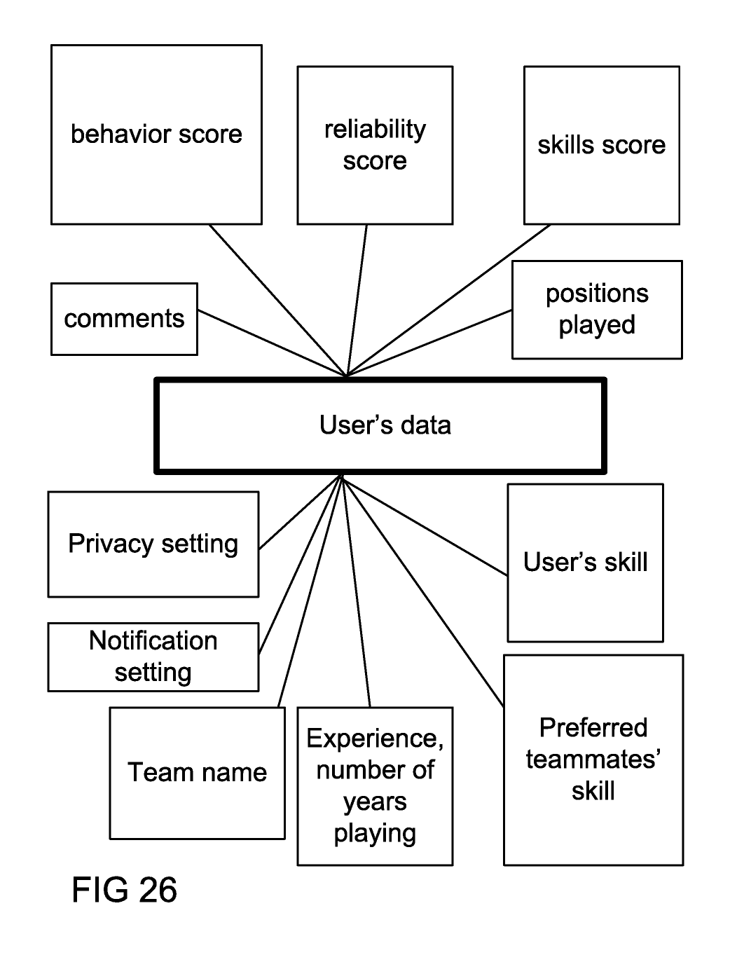

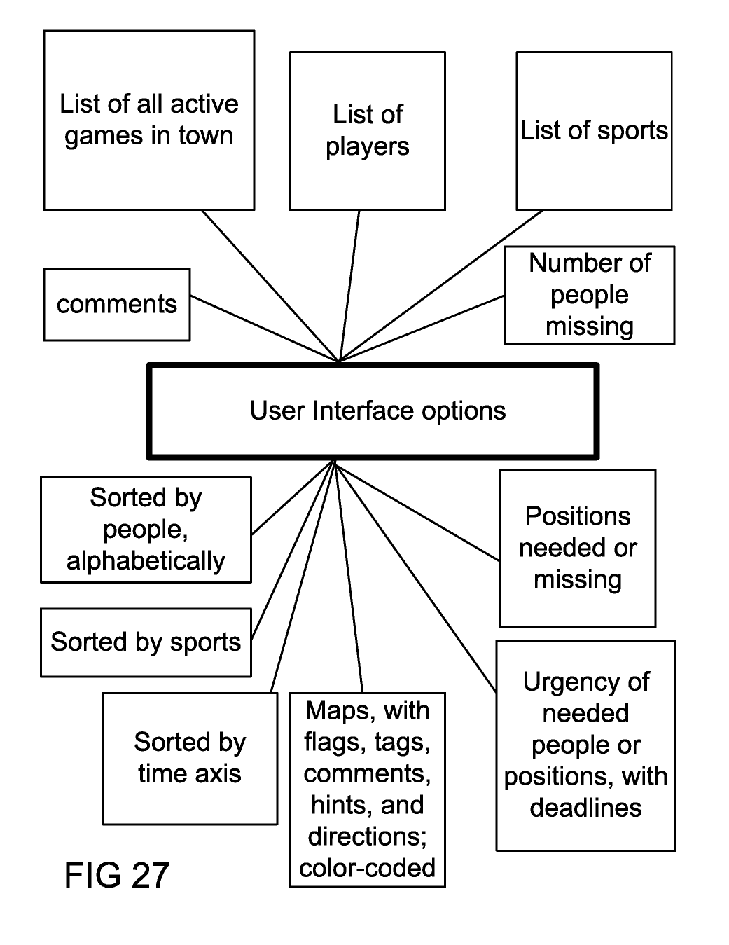

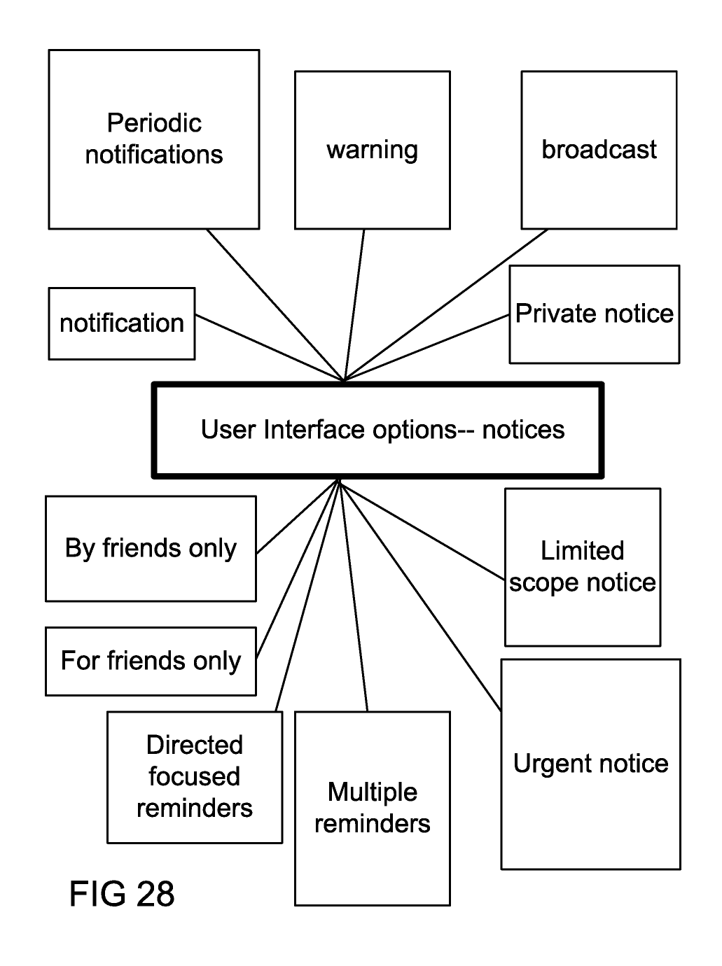

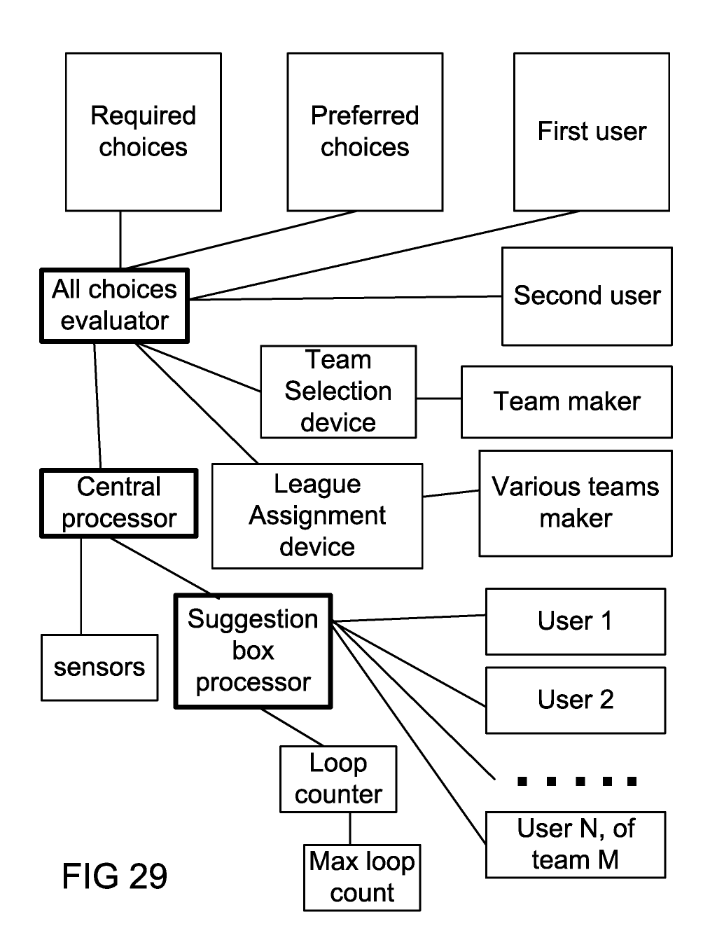

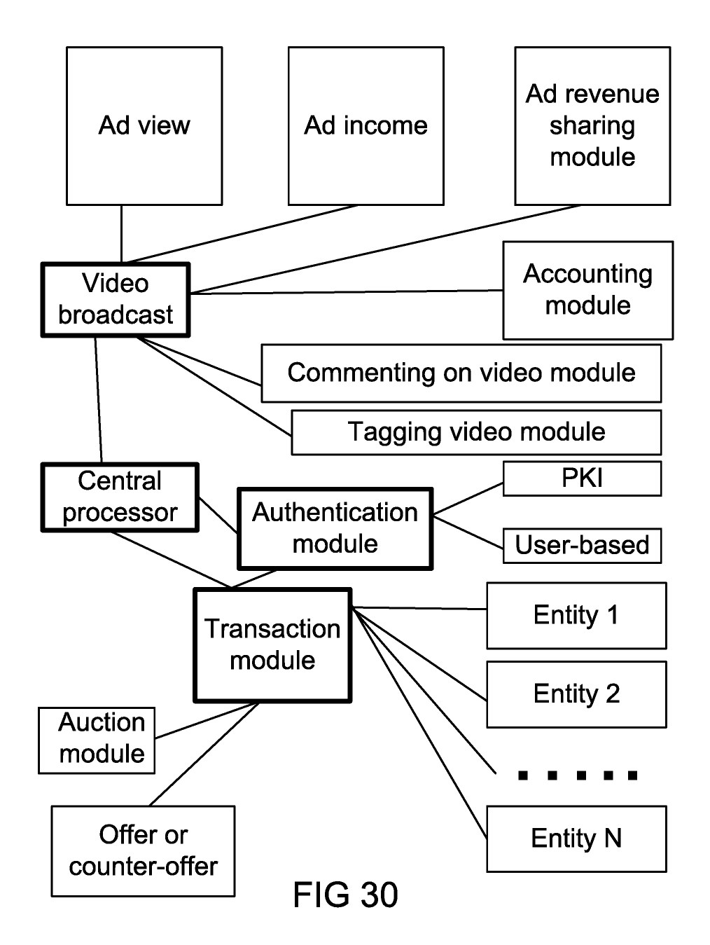

FIG. 23 is for one embodiment, as an example, for user's data. FIG. 24 is for one embodiment, as an example, for more user's data. FIG. 25 is for one embodiment, as an example, for user's options. FIG. 26 is for one embodiment, as an example, for other user's data. FIG. 27 is for one embodiment, as an example, for more user interface options. FIG. 28 is for one embodiment, as an example, for notices. FIG. 29 is for one embodiment, as an example, for our system, showing some advantages/features over prior art. FIG. 30 is for one embodiment, as an example, for our system, with the subcomponents of the system.

In one embodiment, one goes to a new town or area, or plans to go there in the future, and one sets up a team or league or teammates to play with, in advance, with all parameters of the game set up, e.g., time, location, reservation of venue, reservation of the equipment, ball, coach, referee, cleaning staff, maintenance staff, fees, membership fees, scheduling, conflict removal, clothing, shoes, stick, backup equipment, cameras, videos, income, or advertisement on display, e.g., on the board, screen, wall, field, or clothing.

In one embodiment, when there is a conflict e.g. for the stadium reservation or field reservation, one has the option to pay-off and compensate the other side, to give up their rights or reservation, for conflict removal, which can be a fixed amount, or variable or percentage or negotiated as offer/counter-offer, back and forth, or as auction price, bidding, if many parties are involved, to reserve a field or net, for the highest bidder.

In one embodiment, when one sell ads for videos from the game or play, streaming or rebroadcasting live or at a later time, for the right to see or save the game or record, using the mobile cameras or video recorders or phones or wearable cameras on the players' head or helmet or on his body or clothing or equipment, or stationary cameras on the field or stadium or on the sides or balloon or on a drone flying on or over the game or field, for copyrights or intellectual properties, for funny stuff or interesting games or serious reasons or training purpose or just for friends/family to see. They can put this in their website for the ad revenue or revenue sharing in public places, e.g., through Facebook or Youtube or our websites. These digital rights managements are all tracked and recorded by our system, to increase revenue, interests, and userbase or audience or players or just general public participation. The revenue distribution is also done through our system and website or app.

In one embodiment, when one needs a piece of equipment or shoe, or a coach for a sport, or a referee, then he or she can find the match in our website, or 2 people can buy/sell or exchange the object or provide services on our website, based on the agreed price or contract or predetermined contract online or percentage of the deal or ad revenue, or based on auction price, to bet on that, with open or hidden values or dollar amounts on auction. The/our website facilitates such matches and transactions, and may or may not get any fee or percentages or min. commission fees, or just do it to attract people in the website, or just host the request or offers for services or objects, e.g., ball, shoes, being a referee, being a coach, or the like, based on rental of server/space/bandwidth/traffic/download/upload amount, on cloud or network.

In one embodiment, when one needs a field or stadium or swimming pool, e.g. for water polo, or tennis court, or soccer field/grass area, through public or private owners or cities or government entities, they can go through us, to reserve or pay or bid or participate in a raffle or lottery or drawing to win a right to have a space or location, or based on first-come-first-serve rule, or using an offer to buy or bid on location, right, priority date, or reservation, or compensate others to give up their reservation in somebody else's favor or to replace them. So, we facilitate the exchanges, transactions, offers, auctions, reverse-auctions, or compensations, as well as contracts and e-signed deals with PKI security between two or more parties, which otherwise would be impossible to get together and make it happen, e.g., in prior art or other websites.

In one embodiment, one can find the teammates from scratch, even from remote, from another city, even before real/physical moving to the new location. Kids participate in more team sports, which has cultural and health benefits, especially during Summers. In one embodiment, the position of the teammate is specific or mandatory or optional or preferred or flexible, e.g., one needs a goalkeeper or goalie for soccer game.

In one embodiment, the location may be specific or mandatory or optional or preferred or flexible, e.g., one needs a specific field or stadium or venue or building or area or neighborhood or close-to-metro-station-place for soccer game. In one embodiment, the min or max number of players are specified. In one embodiment, the male or female or mixed players is specified. In one embodiment, the ages of players are specified, or as a range, or height/weight, or max or min or average or median values, e.g., for wrestling or boxing matches, the weight is important. In one embodiment, it can be team sports or a league type, or just individual sports or game, just advertising for audience to come and watch an event, e.g., a high jump event by a single person, inviting friends or just public/strangers/interested people, to come and see it in, e.g., a nearby high school stadium.

In one embodiment, it can be connected to social media, for distribution or for enrollment or for authentication or for public confirmation/acceptance. It can have options for game, position played, or preferred, or best talent, or best performance, with rating by himself or others or teammates or public, watching the game, live, or broadcasted or taped or on Youtube or on our website or game's or team's websites. In one embodiment, at the end of the game, they rate/rank each other, locally or globally or relatively. In one embodiment, user advertises for difficult positions, or advertises for particular skills in the game, or wants fun people in the game, based on personalities, or for preferred teams or team members or general definitions or specific definitions or parameters or by names or by generic properties, or by title or reputation, e.g., best goalkeeper for soccer in this area, voted by coaches or team members or public or friends, or based on scores or saves or rebounds or home-runs or the like, using automated counter or computer or processor.

In one embodiment, it can be for professional teams or local or leisure teams. In one embodiment, it can have a point or score or history or statistics, so far or this game or this season or average or relative to others, for players, e.g., for bragging rights. In one embodiment, one can recruit remotely. In one embodiment, one can record, upload, and annotate video, e.g., saying that: “at the time equal to 2 minutes, a great goal, or a funny play, goofy play, or an impossible situation, happening”, for others to look at, or search, or rank, or like, or dislike, or share, or forward, or write about, or comment on, or print, or copy, or advertise for, or get money on ads, or revenue sharing on ads, or count the viewers so far, or count the unique viewers so far, or brag about, or add score, or add points or cash equivalent.

In one embodiment, it can be tournaments for funniest or best or most difficult plays or players or situations, with awards to winners, and rankings, updated daily, or displayed and highlighted, or shown or distributed online, with tags and timelines on best situations on video or images, attached. In one embodiment, it can be push notification, for notice for leagues and teams. In one embodiment, friends on social media get automatic notices.

In one embodiment, it can be friends, close-friends, acquaintances, associates, connections, links, contacts, 2^{nd}-order-friends or contacts, 3^{rd}-order contacts, and the like, for the proximity and privacy and sharing and access control or automatic sharing or authentication or level of access or tiers of distribution or permission levels, or confidentiality, or access to video or images or tags or comments, or editing those, or forwarding those, or sharing those, or sub-access those to others, or sub-license those rights, for setting at the beginning, for defaults, by user, by admin, by manager, by owner, or by director, or for connection to social media and vice versa, or the like.

In one embodiment, we have the following features as choices/in menu: equipment rental or purchase, condition to join the team, requirements to join the team, number of people needed, skill sets needed, position of players needed, e.g., forward, defense, guard, or the like, flexibility on position needed or applied for, ranking or preference for that, multiple positions sign up, salary and bonus or result-based compensation or percentage income basis, for each position or participation or result of the game or score or winning or score average or score differential or the like.

In one embodiment, as an example for a situation, we have the situation that one (John) selects a location for field/stadium to play soccer, and finds 5 people interested in playing with his team, against another team in a league, already organized, through our interface/website/app. Then, John suggests a time and date for the game. The first step, it goes through his team, and if all agree, then it goes to the opposite team to verify that all of those agree, as well. However, if one of them disagrees, he can put a counteroffer on the date/time, and send it back to the original team and the 2^{nd} team for another round of voting, as a loop, and if one person holds up the votes, after N rounds or asking/loops, then, the team with one holdup player shall try to find a backup player for this game, and if found, then the search for team is over. Then, all agree on date, and then they ask from stadium management or server if that time is OK with them. If yes, then the search is over, and all parties are notified electronically for time and location. If not available, then using the map, the user is looking for all nearby venues, within some threshold distance. (See FIGS. 29-30.)

Then, if one finds one nearby, which is available, it will ask all from both teams that if they agree to the backup location, which is available for that time/date. If all agree, then it records in everybody's calendar for reminder, automatically, as all previously gave permission for such action in their email/calendar system, during signup with our website, or through their social network. (See FIGS. 29-30.)

Then, in some intervals before the event, reminder emails or texts are sent to warn or remind the users about upcoming game with all details, from the main server. Now, if there is a hurricane coming toward the city on that date, and the sensors detect the sudden temp/pressure changes, or wind speed at above a threshold, at the chosen stadium, as the pattern predicts, by the processor, for storm approaching, then it will cancel the event and send notifications by email or text to all 2 teams involved, about the storm, as well as referee(s) and coaches for both teams, asking for a rescheduling from users, going through the same loop as above, until it settles again, and the event successfully happens. (See FIGS. 29-30.)

These loops above can continue until a result is obtained and it exits the loop, or a max number of loop happens, as an option, to exit, with no result, and it gives the notification that this game cannot be happening with the current conditions or constraints, and the users can initiate another loop to start another scheduling from scratch, hopefully, with different parameters, resulting in a successful ending. (See FIGS. 29-30.)

In one embodiment, for security purpose, the identity of people are authenticated, to make sure that the teammates are voting, with the confirmed identification. One way is to use the PKI (public key infrastructure) method for authentication of identity of people. (See FIGS. 29-30.)

Another way is that we use a specific attribute/parameter/knowledge of the user, as our method, as one embodiment. In this case, the last/previous time that the user suggested a date for the game, the date was recorded, and can be used for such a purpose. So, if for example, the user 1 (e.g., Jack Smith, or “Jack”) suggested 1 Jul. 2017 at 8:30 am for the time for the game, at the last session, which happens to be a Saturday, then we will have, for our novel method, as described here, by way of an example: (See FIGS. 29-30.)

“1 Jul. 2017 at 8:30 pm” converts to 01-07-2017-20-30 (i.e., time expressed in military time, of 24 hours). Please note that “01” denotes the 1^{st} of month, “07” denotes July, “20” denotes 8 pm, and “30” denotes 30 minutes. So, we will have: “010720172030”, as an integer, identifying user 1 (Jack).

To make that more secure, in another embodiment, we know that that date is a Saturday (or 6^{th} day of the week, assuming that Monday is the 1^{st} day of the week). So, it maps to integer/number “6”, as the 6^{th} day of the week/Saturday. So, Jack is identified by a pair of integers: (010720172030, 6)

So, the second number further verifies the identity of Jack in the system, for further verification/authentication.

Now, to make that even more secure, as another embodiment, one can add a function/operation on the pair of integers (for example, the operation of “addition”, or “+”, to add the 2 numbers, which yields another integer, e.g., “010720172036”, in this example, used to identify Jack), as previously agreed upon/known, or as it changes every week/day, but known to the users, for its pattern of change, from a table, or schedule (e.g., this week/day, the chosen operation is “addition”), or just get notified separately on different format or method, as what the operation currently is, for example, by tel., using voice message, to notify people separately, about the chosen operation currently in use/in effect. So, this identifies Jack for the rest of teammates.

Now, to make that even more secure, as another embodiment, one can add the digits of the number above (“010720172036”), to produce another integer:

0+1+0+7+2+0+1+7+2+0+3+6=29

So, this last number, 29, is a hash version of the code above, “010720172036”, which can also be used to identify Jack, alone or in combination with above codes. (Of course, having a hash value, it can map to multiple original values, but the chances are generally low to accidentally get the same hash value.)

Now, to make that even more secure, as another embodiment, one can add the digits of the number above (“29”), to produce another integer, as another hash:

2+9=11

, which can also be used to identify Jack, alone or in combination with above codes.

Now, to make that even more secure, as another embodiment, one can add the digits of the number above (“11”), to produce another integer, as another hash:

1+1=2

, which can also be used to identify Jack, alone or in combination with above codes.

So, any of the methods above can be used to identify/authenticate the person. This can be included in a file, or attached to another file, or embedded in a file, or as a header in the file, or the like. This method does not require the processing power needed for PKI implementation. Thus, it is advantageous in that regard. (See FIGS. 29-30.)

In one embodiment, we have the following features as choices: A method of invitation and coordination for a game or sport, said method comprising: a first user selecting a first set of parameters for said game or sport as first required choices, through a user-interface connected to a central processor; said first user selecting a second set of parameters for said game or sport as first preferred choices, through said user-interface connected to said central processor; a second user selecting a third set of parameters for said game or sport as second required choices, through said user-interface connected to said central processor; said second user selecting a fourth set of parameters for said game or sport as second preferred choices, through said user-interface connected to said central processor. (See FIGS. 29-30.)

In addition, a selection device or module assigning said first user to said second user as a teammate for a first team for said game or sport, based on first matching score for matching said first preferred choices versus said second preferred choices, and with a condition of complete coverage and full matching of said first required choices versus said second required choices; an assignment device or module selecting a second team for said game or sport for a first league for said game or sport, to compete with said first team in said first league, with said second team having a second team preferred choices and a second team required choices; wherein said assignment device or module selects said second team based on second matching score for matching said first preferred choices and said second preferred choices versus said second team preferred choices, and with a condition of complete coverage and full matching of said second team required choices versus said first required choices and said second required choices. (See FIGS. 29-30.)

In addition, said first user suggesting a first time and a first location for a first game, through a suggestion box's interface attached to said central processor; said suggestion box sending a first text, note, or email to said second user, regarding said first time and said first location for said first game; said second user approving said first time and said first location for said first game, delivered to said suggestion box; said suggestion box sending a second text, note, or email to said second team, regarding said first time and said first location for said first game; said second team approving said first time and said first location for said first game, delivered to said suggestion box; said suggestion box sending a third text, note, or email to said second team, said first user, and said second user, regarding approval of said first time and said first location for said first game. (See FIGS. 29-30.)

Other options/features are: (See FIGS. 29-30.)
receiving data from sensors monitoring weather at or near said first location.
said data from sensors monitoring weather at or near said first location indicates a storm approaching said first location at or about said first time.
cancelling said first game in a main calendar.
sending a fourth text, note, or email to said second team, said first user, and said second user, regarding cancellation of said first game at said first time and said first location.
said second team, said first user, or said second user suggesting an alternative time for said first game.
said central processor continuing a loop for suggestion for said first game, until said first game is set or approved by said second team, said first user, and said second user.
said central processor continuing a loop for suggestion for said first game, until a counter counting number of said loop exceeds a predetermined loop threshold.
selecting a referee.
selecting a coach.
taping a game as a video.
tagging said video for interesting or funny moments.
commenting on said video.
broadcasting said video.
advertising on said video.
revenue-sharing for ads on said video.
giving offers or counter-offers for said revenue-sharing for said ads on said video.
auctioning for said revenue-sharing for said ads on said video.
authenticating people voting or approving said first time and said first location for said first game, through said suggestion box.
said authentication is done by public key infrastructure method.
said authentication is done by a method based on a specific parameter or characteristic of a player.

In one embodiment, we have the following features as choices/in menu, for our website, for PlayUs:
Moving position of player, or choices available.
Broadcast notices of events or games.
Get advice from friends or public.
Generic sports or specific sports, e.g., snow-boarding, volleyball, tennis, baseball, or the like.
Rules for tournament: elimination, play-off, best 2 teams in each group, or the like.
Ads for sports merchandise or users or audience.
For facilities: venue, reservation, voting for location, location of players on the map, proximity of players, convenience of players, or audience, or public.
Rating on players, equipment, stadium, referee, coach, teammates, other players, manager, website, skills, character, fun-character, fair-character, likeable-character.
Rating/voting for field/venue, for quality of grass, fees, management being nice and helpful, hours of operation, covered field, good weather or temperature, distance to metro, distance to people, reservation steps/ease.
Filtering: for tournament, games, players, fields, cities, sports, leagues, or the like.
Pickup game or on-spot.
Other companies sponsor the games or pay for stadium, clothing, rents, referee, coaches, or players, e.g., Nike. Show the symbol or trademark of the sponsor during the game or in video. It is a source of income.
Database of all games, venues, players, referees, coaches, cities, stadiums, seasons, leagues, or sports, and stats for all of those, behavior, quality, availability, experience, likeability, fairness, character, or the like. All of these are for review, rent, copy, or print, based on fee, percentage, or free. It is a source of income.
Lottery to reserve a place or venue, with or without fees.
Various actors in the ecosystem: Team captains, league commissioner, multiple leagues/teams, various sports, city hall/mayor/government in charge of public venues.
Venue operating model option.
Consumer focused, or league-centered, model option.
Unofficial team for university.
Recruiting for university or pro-teams.
Skill and position types or classes for various sports.
Behavior of people: penalty or sanctions, e.g., eject a player from a league forever.
Privacy: circle of distributions/trust: announcements and notices.
Manager reserves a field/stadium.
Live feed to watch a game, free or fee based or subscriptions or must-watch-ads-in-between.
Points based, for gifts, cash, shoe, clothing, free lunch, or free stadium, ball, coaching, referee, or the like.
Waiting list for backup, or for no-show.
Random selection or lottery for overbooked or over-demand/limit, for resources and parameters, e.g., stadium.
Who brings the ball.
Manager in charge of the team gathering.
Proposal, e.g., who pays for rental, e.g., one suggests covering half of the cost for the whole team, and the site charges his credit card or bank account or other accounts.
MVP for the team or league.
Feedback loop or blog or comment section.
For training, for fun, for practice, or for increasing the membership.
Player to player message/communication, or by/to/from manager, or team owner, or captain, or league owner, or admin, or referee, or coach.
Tournament sponsor or organizer running the league.
Resume for players, or experience, or background, or other info.
Tennis: e.g., clay-player, left-handed, tall, good serves.
Stadium: facility: ranking, experiences, comments, likes, dislikes, camera available.
Emergency facility, doctors, hospitals, 911, closest to the location, discount from insurance companies, covering injuries in the game only, contract with insurance companies for all the sponsored games.
Points for players, bragging rights.
Gamification, to encourage more participation.
Best player: sponsor, ads, promote through us, votes, resume, stat, history, summary sheet, salary, profit sharing, pictures on site, trophy, shoe endorsement, gifts, awards.
Giveaway: tickets for game or plane.
Random assignment of positions.
Reporting abusive behavior or people.
Professional club or team sponsoring, or recruiters for them or colleges.
Weather forecast: service: warning and notices: change the venue or time or cancel or postpone or delay or instruct to stay home.
Specify who wants to be your teammate, or reverse matching, or matching from both sides/one side.
Also applies to: Pinball game, video game, card game, other games.

Any memory or storage unit can be used here, for various applications, e.g., RAM, ROM, hard drive, backup, optical or magnetic storages, CD, CD-ROM, tapes, disks, removable drives, internal drives, cloud storages, or the like. In addition, we have processor, microprocessor, central computer, server farms, terminals, controller, logic board, pad, mobile device, communication device, smart phone, or the like, in the system. Any variations of the above teachings are also intended to be covered by this patent application, as well as any combination of any two or more embodiments.

1. A method of invitation and coordination for a game or sport, said method comprising:
a first user selecting a first set of parameters for said game or sport as first required choices, through a user-interface connected to a central processor;
said first user selecting a second set of parameters for said game or sport as first preferred choices, through said user-interface connected to said central processor;
a second user selecting a third set of parameters for said game or sport as second required choices, through said user-interface connected to said central processor;
said second user selecting a fourth set of parameters for said game or sport as second preferred choices, through said user-interface connected to said central processor;
a selection device or module assigning said first user to said second user as a teammate for a first team for said game or sport, based on first matching score for matching said first preferred choices versus said second preferred choices, and with a condition of complete coverage and full matching of said first required choices versus said second required choices;
an assignment device or module selecting a second team for said game or sport for a first league for said game or sport, to compete with said first team in said first league, with said second team having second team preferred choices and second team required choices;
wherein said assignment device or module selects said second team based on second matching score for matching said first preferred choices and said second preferred choices versus said second team preferred choices, and with a condition of complete coverage and full matching of said second team required choices versus said first required choices and said second required choices;
said first user suggesting a first time and a first location for a first game, through a suggestion box's interface attached to said central processor;
said suggestion box sending a first text, note, or email to said second user, regarding said first time and said first location for said first game;
said second user approving said first time and said first location for said first game, delivered to said suggestion box;
said suggestion box sending a second text, note, or email to said second team, regarding said first time and said first location for said first game;
said second team approving said first time and said first location for said first game, delivered to said suggestion box;
said suggestion box sending a third text, note, or email to said second team, said first user, and said second user, regarding full approval of said first time and said first location for said first game.

2. The method of invitation and coordination for a game or sport, as recited in claim 1, said method comprises:
receiving data from sensors monitoring weather at or near said first location.

3. The method of invitation and coordination for a game or sport, as recited in claim 2, wherein said data from sensors monitoring weather at or near said first location indicates a storm approaching said first location at or about said first time.

4. The method of invitation and coordination for a game or sport, as recited in claim 3, said method comprises:
cancelling said first game in a main calendar; and
sending a fourth text, note, or email to said second team, said first user, and said second user, regarding cancellation of said first game at said first time and said first location.

5. The method of invitation and coordination for a game or sport, as recited in claim 4, said method comprises:
said second team, said first user, or said second user suggesting an alternative time for said first game.

6. The method of invitation and coordination for a game or sport, as recited in claim 5, said method comprises:
said central processor continuing a loop for suggestion for said first game, until said first game is set or approved by said second team, said first user, and said second user.

7. The method of invitation and coordination for a game or sport, as recited in claim 5, said method comprises:
said central processor continuing a loop for suggestion for said first game, until a counter counting number of said loop exceeds a predetermined loop threshold.

8. The method of invitation and coordination for a game or sport, as recited in claim 1, said method comprises:
selecting a referee.

9. The method of invitation and coordination for a game or sport, as recited in claim 1, said method comprises:
selecting a coach.

10. The method of invitation and coordination for a game or sport, as recited in claim 1, said method comprises:
taping a game as a video.

11. The method of invitation and coordination for a game or sport, as recited in claim 10, said method comprises:
tagging said video for interesting or funny moments.

12. The method of invitation and coordination for a game or sport, as recited in claim 10, said method comprises:
commenting on said video.

13. The method of invitation and coordination for a game or sport, as recited in claim 10, said method comprises:
broadcasting said video.

14. The method of invitation and coordination for a game or sport, as recited in claim 13, said method comprises:
advertising on said video.

15. The method of invitation and coordination for a game or sport, as recited in claim 14, said method comprises:
revenue-sharing for ads on said video.

16. The method of invitation and coordination for a game or sport, as recited in claim 15, said method comprises:
giving offers or counter-offers for said revenue-sharing for said ads on said video.

17. The method of invitation and coordination for a game or sport, as recited in claim 15, said method comprises:
auctioning for said revenue-sharing for said ads on said video.

18. The method of invitation and coordination for a game or sport, as recited in claim 1, said method comprises:
authenticating people voting or approving said first time and said first location for said first game, through said suggestion box.

19. The method of invitation and coordination for a game or sport, as recited in claim 18, said method comprises:
said authentication is done by public key infrastructure method.

20. The method of invitation and coordination for a game or sport, as recited in claim 18, said method comprises:
said authentication is done by a method based on a specific parameter or characteristic of a player.
